(19) United States
(12) Patent Application Publication
(10) Pub. No.: US 2025/0336173 A1
(43) Pub. Date: Oct. 30, 2025

(54) METHOD FOR RECORDING AN OVERALL IMAGE OF THE SURROUNDINGS OF A WATERCRAFT, DEVICE ARRANGEMENT AND CAMERA

(71) Applicant: Eagle-Marine GmbH, Donzdorf (DE)

(72) Inventor: Maximilian Groll, Ottenbach (DE)

(73) Assignee: Eagle-Marine GmbH, Donzdorf (DE)

(21) Appl. No.: 19/193,284

(22) Filed: Apr. 29, 2025

(30) Foreign Application Priority Data
Apr. 30, 2024 (EP) 24173591.9

(51) Int. Cl. G06V 10/10; G06T 3/4038; G06T 7/73

(52) U.S. Cl. CPC G06V 10/16; G06T 3/4038; G06T 7/73

(57) ABSTRACT

A method captures an overall image of an environment of a watercraft, wherein individual shots are captured by at least two cameras, wherein the cameras are arranged at different positions on the watercraft. At least a relative position and/or a relative orientation of one of the cameras is determined by a device assembly that includes the cameras, wherein the overall image is created from the individual shots using the relative positions and/or the relative orientations. A device assembly contains a camera.

### CROSS-REFERENCE TO RELATED APPLICATIONS

This application is a New U.S. Patent Application which claims priority to European Patent Application No. EP 24 17 3591.9, filed on Apr. 30, 2024, the content of which is hereby incorporated by reference in its entirety.

### BACKGROUND OF THE INVENTION

### Field of the Invention

The invention relates to a method for capturing an overall image of an environment of a watercraft, to a device assembly, and to a camera.

Such methods and device assemblies are used, for example, to capture all-round views around a watercraft, such as a boat. Such all-round views can be used to monitor, without gaps, an external environment around the watercraft. Such all-round views can also make it easier to maneuver the watercraft.

### Description of Related Art

The device assemblies usually comprise multiple cameras. The cameras are installed around the watercraft, in the side walls thereof. The all-round view is calculated from individual shots captured by the cameras.

In the case of land vehicles, device assemblies for capturing an all-round view around the land vehicle have become widespread. They are typically installed at predetermined positions in the land vehicle at the time of manufacture thereof. As a result, only a few calibrations are necessary. These calibrations can often also be carried out simply by aiming at fixed reference points.

However, device assemblies developed for land vehicles generally cannot be used on watercraft. Due to the wide variety of different types of watercraft, device assemblies and methods for watercraft are usually retrofitted, rather than being installed at the time of manufacture of the watercraft. The positions at which the cameras are installed are therefore variable. Reference points in the water generally cannot be used for calibration since the position thereof, in particular relative to the watercraft, is often not sufficiently constant. For calibration, therefore, the watercraft must first be brought ashore, the device assembly must be calibrated, and then the watercraft must be put back into the water. This is inconvenient and time-consuming.

### SUMMARY OF THE INVENTION

The object of the present invention is therefore to provide methods and devices which facilitate particularly easy-to-use overall images of environments of a watercraft.

### BRIEF DESCRIPTION OF THE DRAWINGS

FIG. 1 shows a schematic plan view of a watercraft with a device assembly, the watercraft being located in a berth.

FIG. 2 shows a plan view of a camera.

FIG. 3 shows a perspective oblique view of the camera.

FIG. 4 shows a schematic representation of the structure of the camera.

FIG. 5 shows a schematic representation of two cameras capturing the same feature.

FIG. 6 shows a flowchart of a method.

### DETAILED DESCRIPTION OF THE INVENTION

The object is achieved firstly by a method for capturing an overall image of an environment of a watercraft, wherein individual shots are captured by at least two cameras, wherein the cameras are arranged at different positions on the watercraft, wherein at least a relative position and/or a relative orientation of one of the cameras, in particular relative to the watercraft and/or relative to another of the cameras, is determined by a device assembly that includes the cameras, wherein the overall image is created from the individual shots using the relative position and/or the relative orientation.

An environment of the watercraft can be monitored with the aid of the overall image. Therefore, the invention also relates to a method for monitoring an environment of a watercraft, wherein an overall image is generated according to the method described above, and then the overall image is evaluated with regard to changes over time. In one particularly advantageous variant, changes in objects, for example a new appearance of objects or a disappearance of objects and/or a displacement of objects, can be detected in the overall image. When a change is detected, in particular a specified change, for example an object coming closer to the watercraft to within a predefined threshold, an alarm can be triggered.

The method thus makes it possible, for example, to detect dangerous situations and preemptively resolve them. As a result, accidents involving the watercraft can be avoided. In addition, thanks to the better overview provided by the overall image, the watercraft can be maneuvered more easily and precisely, for example in order to moor the watercraft at a mooring.

The invention also relates to a method for controlling a watercraft, wherein an environment of the watercraft is monitored according to the method described above, and a new command is sent to a control system of the watercraft and/or to an engine of the watercraft as a function of the detected change. This then enables autonomous or at least partially autonomous control of the watercraft with the aid of the overall image.

The relative position and/or the relative orientation can be determined relative to a reference point on the watercraft. As an alternative or in addition, these can be determined relative to another of the cameras.

The cameras may be optical cameras. They may be 2D or 3D cameras. If the cameras also comprise a distance meter, for example based on ultrasound, radar or LIDAR, additional distance information can be included in the overall image, so that, for example, maneuvering of the watercraft in otherwise confusing environments can be made much easier and the risk of accidents can be reduced.

The overall image may cover at least 180°, in particular 360°, of an environment around the watercraft. It may be determined as a fictitious aerial view, i.e. as a view from a fictitious viewing point on top of or above the watercraft.

The device assembly can determine the relative positions and/or relative orientations. Required calibrations can thus take place automatically, so that the method can be used very easily. There is no need for time-consuming and error-prone manual calibrations. The watercraft need not be taken out of the water for calibration. This therefore makes it much easier to create overall images of watercraft.

The relative positions and/or the relative orientations may be determined continuously and/or in a recurrent manner. Temporary tilting movements of the watercraft can thus also be compensated for overall, so that the accuracy of the overall image can be increased.

In one variant of the method, it is conceivable to determine the relative positions and/or the relative orientations separately in the context of a calibration process that is to be carried out, for example when installing the cameras.

In the case of such a calibration process, it is therefore conceivable that the device assembly determines the relative positions and/or the relative orientations after the cameras have been installed on the watercraft.

The remaining phases of the method can then be carried out. In particular, individual shots can be captured by the installed cameras on a one-off or recurrent basis, and then overall images can be created using the previously determined relative positions and/or the relative orientations.

Preferably, the relative positions and/or the relative orientations of each of the cameras relative to each of the other cameras are determined by the device assembly. To this end, it may be sufficient to determine the relative positions and/or orientations of each of the cameras relative to a reference point on the watercraft.

In one variant of the method, it is conceivable that at least one of the relative positions and/or relative orientations is determined with the aid of a position sensor, wherein the position sensor is designed to determine a position and/or an orientation of the associated camera. With the aid of the position sensor, the relative position and/or the relative orientation can thus be determined particularly reliably, in particular regardless of weather and visibility conditions.

The position sensor may be permanently connected to the rest of the camera, i.e. may form a unit therewith.

As an alternative or in addition, it is also conceivable that the position sensor is only temporarily arranged on the camera. To this end, the camera may have a docking point, onto which the position sensor can be docked in a defined position.

The relative positions and/or orientations of multiple cameras can then be determined one after the other using only a few position sensors, in particular using just one single position sensor. By way of example, the position sensor may be part of a smartphone or other portable computer. Material costs can be reduced as a result. A subsequent, very easy recalibration is also conceivable, particularly if, for example, a position sensor of a smartphone or a similarly common portable computer is used.

As an alternative or in addition, image data from at least one of the individual shots may be evaluated in order to determine the relative position and/or the relative orientation. It can be assumed while carrying out the method, for example, that the cameras are located in a maritime environment, thus typical image data of maritime environments that makes it possible to deduce the relative position and/or the relative orientation can be evaluated. Such data may be, for example, a shadow, a direction of incidence of light, for example sunlight, certain typical geometric shapes, for example a typically vertically oriented breakwater, a horizon line that is by definition oriented horizontally, or the like. It may be provided to search for and/or detect maritime objects, for example certain navigation marks or landing stages, in the image data. Data such as dimensions or length ratios, for example a ratio of width to height, for example of the navigation mark or landing stage, may be known for the maritime objects. This data relating to the maritime objects can then be used to determine the relative position and/or the relative orientation.

It is also conceivable to capture time series of individual shots and to establish relationships between the individual shots from different cameras, for example by means of correlation analyses, and to use these relationships in turn to determine at least one of the relative positions and/or relative orientations. Such evaluations are also possible on an ongoing basis. They do not require a separate position sensor and thus can be implemented at low cost.

In particular, it is conceivable first to determine depth information from such image data or specific features, for example by means of self-supervised depth estimation, see for example arXiv:1806.01260v4 [cs.CV] dated 17 Aug. 2019.

Three-dimensional point clouds with x,y,z coordinates of the relevant features can be obtained from this, initially for each of the cameras individually. To this end, the neural network used can be trained by means of self-supervised learning.

The individual, three-dimensional point clouds can then be combined, on the basis of matching features, to form a collective, three-dimensional overall point cloud. The relative positions and relative orientations of the cameras can also be determined in the context of this comparison of features.

On the basis of this overall point cloud, the features from the image data can be projected onto a virtual 3D mesh, thus initially resulting in a three-dimensional overall view. A projection onto a two-dimensional plane is also conceivable.

Variants of the method may provide that processing steps for processing the individual shots take place in a specific order.

In particular, it may be provided that, in a first phase, corresponding features are identified on different individual shots. To this end, the individual shots may for example be segmented with the aid of a segmenter. The segmenter may be implemented with the aid of a neural network.

Preferably, the segmenter may be aligned with image data, in particular trained with image data that has been acquired using optics that are similar to or correspond to the optics of the cameras. For example, if the cameras have fisheye optics, the segmenter can be trained with image data captured using cameras with fisheye optics. The segmenter can be trained with image data that is typical for maritime environments, such as the previous, aforementioned examples of image data from maritime environments. Both real and artificially generated image data can be used for training. In particular, training image data can be generated for training by multiplying and modifying real image data. The modifications may include rotations, perspective distortions, in particular fisheye distortions, as well as lighting effects, in particular reflections, glare, for example by brightening pixels of the image data in certain areas. Our own findings have shown that, in the case of watercraft, the creation of an overall image can be significantly improved if such lighting effects, which are particularly common on water, are depicted in the training image data.

In a subsequent, second phase, the individual shots can then be linearly transformed using the respective relative positions and/or the relative orientations. In this second phase, it is also conceivable to rectify the individual shots, for example to compensate for fisheye distortion. The features can thus be identified on the basis of the individual shots as originally captured. Our own research has shown that more reliable identifications can be achieved as a result.

In a third phase following the second phase, the overall image can then be created from the individual shots, which in particular have been transformed and rectified where necessary, on the basis of the identified features. To this end, multiple individual shots can be stitched together to form an overall image. When doing so, account can be taken of the fact that corresponding features that were originally contained in different individual shots are depicted as one feature and/or lying on top of each other in the overall image.

The stitching-together may be done, for example, using the ORB algorithm in Python-OpenCV.

The method improves the perception of the environment around the watercraft, and thus particularly the safety when maneuvering the watercraft, if the created overall image corresponds to at least a 180° view, in particular an all-round view, i.e. a 360° view.

The invention also relates to a device assembly for capturing an overall image of an environment of a watercraft, comprising at least two cameras which are arranged on a watercraft and/or which are designed to be arranged on a watercraft, wherein the device assembly is designed to carry out the method described above.

The device assembly may comprise a computer.

The computer may comprise a program code which can be executed on the computer and which, when executed on the computer, implements the method. The computer and/or the program code may in particular include the segmenter.

The computer may also comprise a display. The overall image and/or the individual shots can be displayed on the display. It is also conceivable that the computer comprises a signal generator. The signal generator may also be formed with the aid of the display. To this end, the computer may be designed, for example, to display a warning signal on the display when necessary. The signal generator may for example be activated, in particular the warning signal may be displayed on the display and/or an acoustic signal may be emitted, when the device assembly, in particular the computer, and in particular on the basis of the individual shots and/or the overall image, detects a dangerous situation, for example an impending collision of the watercraft with a nearby object, for example a wall of a harbor basin.

A computer program product may comprise a data carrier, on which the program code is stored. If the computer program product has a connection to the Internet, for example, the program code of the computer program product can be stored in a way that is accessible remotely.

The scope of the invention includes, in particular, a device assembly for capturing an overall image of an environment of a watercraft, comprising at least two cameras which are arranged on a watercraft and/or which are designed to be arranged on a watercraft, wherein the device assembly is designed to determine at least a relative position and/or a relative orientation of a camera, in particular relative to the watercraft and/or relative to at least one other of the cameras.

Such device assemblies also enable automatic calibration, thus in turn considerably simplifying the creation of overall images for watercraft.

The device assembly may have one or more of the properties of the device assembly described above. In particular, it may also comprise a computer. The program code described above may be stored on the computer in such a way as to be able to be executed. It may be configured to carry out the method described above.

The device assembly may comprise at least four cameras, in particular at least six cameras. With such an increased number of cameras, it is possible to create 180° views and all-round views with improved resolution.

The device assembly may comprise a position sensor which is designed to detect the relative position and/or the relative orientation. The relative position and/or the relative orientation can thus be determined regardless of environmental conditions, such as daylight or weather.

On the water, there are often only a few features that can be used to determine the relative position and/or orientation in a software-based manner. Such software solutions, for example AI-assisted solutions, also often use probability-based decisions. A hardware-based solution with the aid of the position sensor may therefore often provide more reliable results, particularly in maritime environments.

Preferably, the position sensor may comprise at least a gyroscope, an IMU, i.e. an inertial measuring unit, a compass, in particular an electronic compass, and/or a positioning system. The positioning system may comprise, for example, a satellite-based positioning system using GPS, BAIDU or GLONASS, and/or a radio-based positioning system, for example a Bluetooth-based or WLAN-based positioning system. These technologies enable precise detection and are available at low cost.

The scope of the invention also includes a camera for the device assembly. The camera comprises at least one camera module for capturing individual shots. It may have a fisheye lens for capturing a wide angle of view.

In particularly preferred embodiments, the camera may comprise at least one position sensor which is designed to detect a relative position and/or a relative orientation of the camera.

In particular, the camera may comprise the position sensor or at least one of the position sensors of the device assembly. It is conceivable that each camera of the device assembly has its own position sensor. The relative positions and/or relative orientations of multiple cameras can thus be detected simultaneously.

In particular, the position sensor, even if it is part of the camera, may comprise at least a gyroscope, an IMU, a compass, in particular an electronic compass, and/or a positioning system.

In order to cope with the harsh maritime environmental conditions, the camera may be designed to be dust-resistant and/or water-resistant to at least IP67, in particular to DIN EN 6052 or ISO 20653. It may be at least partially covered by a stainless steel housing.

The aforementioned methods and devices may in particular be used on luxury yachts. To minimize damage during retrofitting, the devices, in particular the cameras, may be designed for trouble-free installation, in particular for installation without having to perforate the side walls.

To this end, it is conceivable that the camera comprises a solar cell, a rechargeable battery, and/or a wireless power interface, for example an inductive power interface. The camera can thus be supplied with power without having to be directly connected to a power cable.

In addition, it is conceivable to transmit data, in particular the individual shots, wirelessly at least over a short distance, for example through a side wall. To this end, the camera may comprise a wireless data interface.

The camera can be attached to the watercraft, in particular to a side wall of the watercraft, in a particularly stable manner if it has a mounting plate. The mounting plate may have mounting holes. The mounting plate can be screwed against the watercraft, for example against a side wall, using the mounting holes.

The camera may also have a docking point, onto which a position sensor can be docked, for example temporarily, with a defined orientation. One position sensor can thus be used for multiple cameras, therefore minimizing manufacturing costs for the device assembly.

Further features and advantages of the invention will become apparent from the following detailed description of an exemplary embodiment of the invention with reference to the figures of the drawing, which show details essential to the invention, and from the embodiments.

The individual features can be implemented individually or jointly in any combination in variants of the invention.

The schematic drawing shows exemplary embodiments of the invention, which will be explained in greater detail in the description below.

In the following description of the figures and in the drawing, the same reference signs will be used for elements that correspond to each other, in order to facilitate understanding.

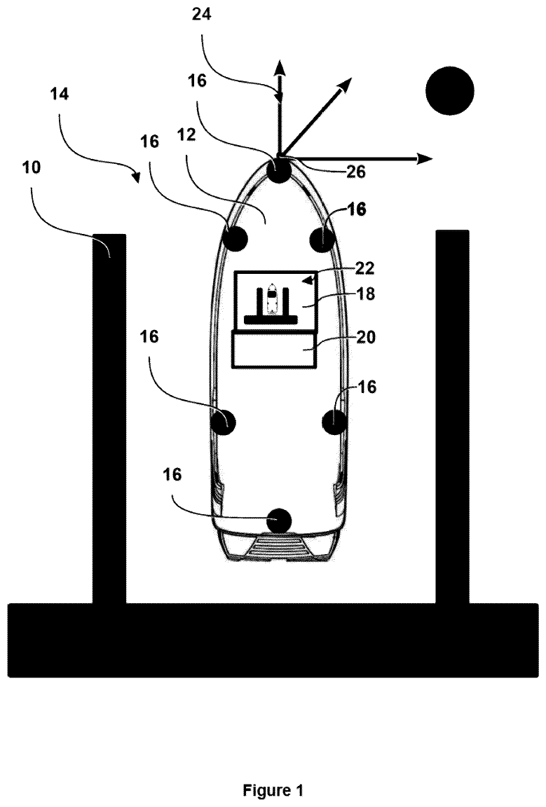

FIG. 1 shows a schematic plan view of a watercraft 12 located in a berth 10.

The watercraft 12 comprises a device assembly 14. The device assembly 14 comprises multiple cameras 16. In the example, the device assembly 14 comprises six cameras 16. The cameras 16 are located on outer walls of the watercraft 12.

The device assembly 14 further comprises a display 18, which is connected to a computer 20.

Shown on the display 18 is an overall image 22, which has been created by the device assembly 14.

Also shown schematically in FIG. 1 is a coordinate system 24 with a reference point 26. Positions and orientations of the cameras 16 can be determined by the device assembly 14 relative to this reference point 26 and the coordinate system 24.

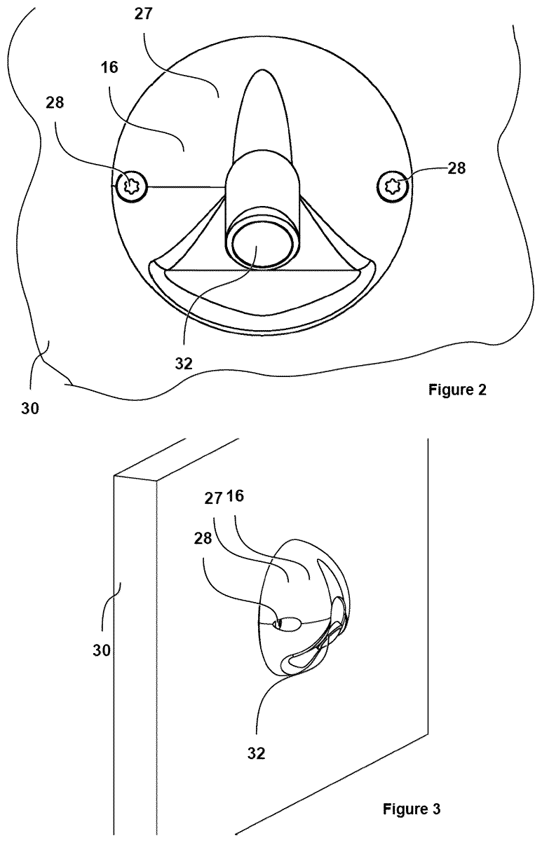

FIG. 2 shows a camera 16 in a perspective plan view, and FIG. 3 shows the camera 16 in a perspective side view.

The camera 16 is attached to an outer wall 30 (shown only schematically in FIG. 2) of the watercraft 12 with the aid of a housing 27 and screws 28. The housing 27 is made of stainless steel.

Overall, the camera 16 is water-resistant and dust-resistant to IP67.

A fisheye lens 32 can also be seen. In the exemplary embodiment of the camera 16 shown here, the fisheye lens 32 is oriented diagonally downward.

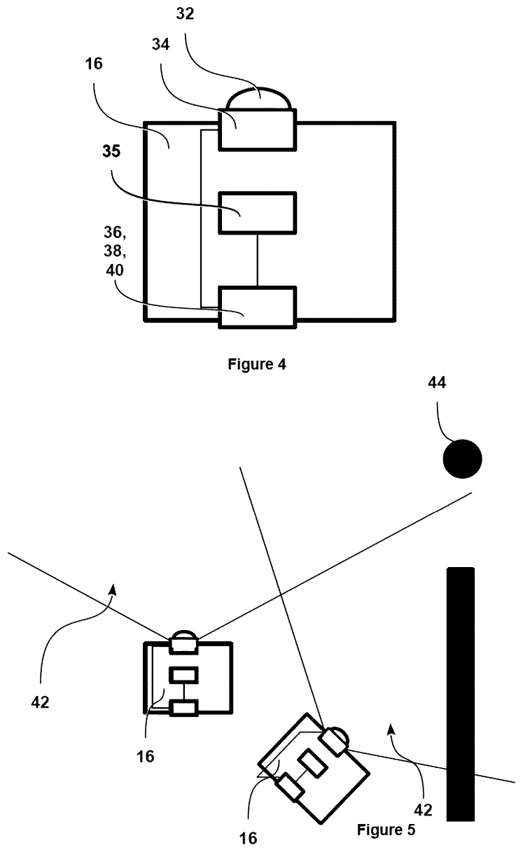

FIG. 4 shows the camera 16 in a schematic view. It can be seen that the camera 16 comprises a camera module 34, on which the fisheye lens 32 is located. The camera module 34 may comprise, for example, a CMOS camera.

The camera 16 additionally comprises a position sensor 35, which comprises an IMU. A position and an orientation of the camera 16 relative to the coordinate system 24 (see FIG. 1) can be determined by the position sensor 35.

The camera 16 further comprises a wireless interface 36. In this exemplary embodiment, the wireless interface 36 is an inductive interface. Via the latter, as a power interface 38, the power required for operation can be supplied to the camera 16. As a data interface 40, it is also designed to transmit data from the camera 16, in particular individual shots from the camera module 34, and from the position sensor 35, to the computer 20 (see FIG. 1). It is also conceivable that the data interface 40 is designed to be bidirectional, so that data, for example control data, can also be transmitted from the computer 20 to the camera 16. In an alternative, wired embodiment, a coaxial cable can be used to supply power and to transmit data.

It is thus possible to screw, glue or otherwise attach the camera 16 to the outer wall 30 (see FIG. 2) from an outer side thereof. A power and data cable can then be laid on the inner side of the outer wall 30, via which power and data can be inductively transmitted from the computer 20 (see FIG. 1), through the outer wall 30, to the camera 16 and can be received by the latter.

FIG. 5 shows two cameras 16 with their fields of view 42 shown schematically in FIG. 5. The two cameras 16 may be, for example, one camera 16 located at the bow of the watercraft 12 and one camera located diagonally at the front of the watercraft 12.

It can be seen that the same feature 44, for example a breakwater, is located in both fields of view 42. Individual shots from the two cameras 16 thus both contain images of the feature 44. Therefore, if the feature 44 is identified as a common feature, the overlapping of the fields of view 42, and thus of the associated individual shots from the two cameras 16, can be deduced therefrom.

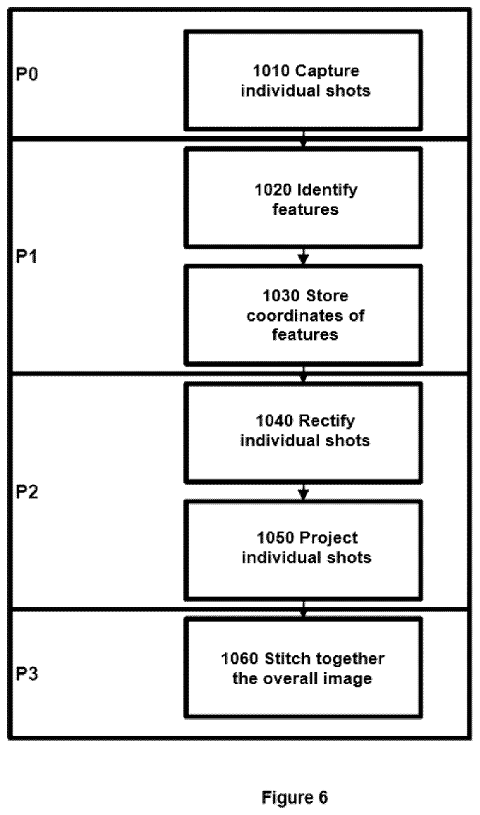

FIG. 6 then shows a flowchart of a method 1000 for capturing an overall image 22 of an environment of the watercraft 12. The reference signs introduced above, in particular with regard to the device assembly 12 and the cameras 16, will continue to be used to describe the method 1000.

In a start phase P0, in particular in a first step 1010 of the method 1000, individual shots are captured by the at least two cameras 16. As can be seen from FIG. 1, for example, the cameras 16 are located at different positions on the watercraft 12.

If, for example, an individual shot of a harbor wall, which in reality is rectangular, is captured, this will be depicted as an ellipse in the associated individual shot due to the fisheye lenses of the cameras 16.

In a subsequent phase P1, the captured individual shots are then analyzed in a step 1020 in order to identify specific features, such as the feature 44 from FIG. 5, in the individual shots. In particular, features that are depicted in multiple of the individual shots, i.e. from different cameras 16, are identified.

In a subsequent step 1030, the coordinates associated with the identified features are stored.

In a subsequent phase P2, the individual shots are first rectified in a step 1040. In particular, the distortions caused by the fisheye lenses 32 are corrected. Following the example of the harbor wall, the ellipse would now be depicted as a rectangle after rectification.

Then, in a step 1050, the relative positions and relative orientations of the cameras 16 relative to the coordinate system 24 are measured with the aid of the position sensor 35. The individual shots are then linearly transformed on the basis of these relative positions and relative orientations. The harbor wall depicted as a rectangle would thus be transformed into a possibly rotated trapezoid.

In one variant of the method 1000, it is conceivable that the relative positions and the relative orientations are measured in the context of a calibration process prior to the phase P0 or during the phase P0. For example, this may be advantageous if only a single position sensor is available for measuring purposes and the relative positions and relative orientations of the individual cameras 16 are measured one after the other by the position sensor.

In a final phase P3, the individual shots are stitched together in a step 1060 to form the overall image 22, taking into account the relationships between the identified features as they existed in the original individual shots. In particular, the individual shots are stitched together in such a way that features that were contained in two individual shots are depicted congruently in the overall image 22.

The overall image 22 can then be displayed on the display 18.

The overall image 22 may be further processed. In particular, the overall image 22 may be analyzed with regard to objects and changes therein using a segmentation algorithm executed on the computer 20. In order to monitor the watercraft 12 during a process of berthing at the berth 10, for example, the overall image 22 may be analyzed for walls and other elements of the berth 10.

It is conceivable to trigger an alarm signal if, as a result of this analysis of the overall image 22, a dangerous situation is detected. The alarm signal can warn a user about an impending accident.

In another method, it is also conceivable that the watercraft 12 is controlled on the basis of the overall image 12, in particular with the aid of this analysis. To this end, a control system of the watercraft 12 may be actuated as a function of the overall image 12, in particular as a function of objects detected in the overall image 12 and/or changes in said objects. The watercraft 12 can thus be controlled, for example, in such a way that it berths at or departs from the berth 10 in a partially autonomous or fully autonomous manner. Analogously, it is conceivable that the watercraft 12, while monitoring its environment on the basis of the overall image 12, travels on a selectable course and/or to a selectable destination in a partially autonomous or fully autonomous manner.

List of reference signs

| | |
|---|---|
| 10 | berth |
| 12 | watercraft |
| 14 | device assembly |
| 16 | camera |
| 18 | display |
| 20 | computer |
| 22 | overall image |
| 24 | coordinate system |
| 26 | reference point |
| 27 | housing |
| 28 | screw |
| 30 | outer wall |
| 32 | lens |
| 34 | camera module |
| 35 | position sensor |
| 36 | interface |
| 38 | power interface |
| 40 | data interface |
| 42 | field of view |
| 44 | feature |
| 1000 | method |
| 1010 | step |
| 1020 | step |
| 1030 | step |
| 1040 | step |
| 1050 | step |
| 1060 | step |
| P0 | start phase |
| P1 | first phase |
| P2 | second phase |
| P3 | third phase |

1. A method for capturing an overall image of an environment of a watercraft, the method comprising:
capturing individual shots by at least two cameras,
wherein the cameras are arranged at different positions on the watercraft,
wherein
at least a relative position and/or a relative orientation of one of the at least two cameras is determined by a device assembly that includes the at least two cameras,
wherein the overall image is created from the individual shots using the relative position and/or the relative orientation.

2. The method according to claim 1, comprising:
determining at least one of the relative positions and/or relative orientations with aid of a position sensor, wherein the position sensor is designed to determine a position and/or an orientation of the associated camera.

3. The method according to claim 1, comprising:
evaluating image data from at least one of the individual shots to determine the relative position and/or the relative orientation.

4. The method according to claim 1, comprising:
identifying, in a first phase (P1), corresponding features on different individual shots, and
in a subsequent, second phase (P2), linearly transforming the individual shots using the respective relative positions and/or the relative orientations, and
in a third phase (P3) following the second phase (P2), creating the overall image from the individual shots on the basis of the identified features.

5. The method according to claim 1, wherein the created overall image corresponds to at least a 180° view.

6. A device assembly for capturing an overall image of an environment of a watercraft, the device assembly comprising:
at least two cameras which are arranged on a watercraft and/or which are designed to be arranged on a watercraft,
wherein
the device assembly is designed to determine at least a relative position and/or a relative orientation of a camera.

7. The device assembly according to claim 6, comprising:
a position sensor which is designed to detect the relative position and/or the relative orientation.

8. The device assembly according to claim 7, wherein the position sensor comprises at least a gyroscope, an IMU, a compass and/or a positioning system.

9. A camera for a device assembly according to claim 6, the camera comprising:
at least one camera module for capturing individual shots.

10. The camera according to claim 9, comprising:
at least one position sensor which is designed to detect a relative position and/or a relative orientation of the camera.

11. The camera according to claim 10, wherein the position sensor comprises at least a gyroscope, an IMU, a compass and/or a positioning system.

12. The camera according to claim 9, wherein the camera is designed to be dust-resistant and/or water-resistant to at least IP67.

13. The camera according to claim 9, comprising:
a solar cell,
a rechargeable battery, and/or
a wireless power interface.

14. The camera according to claim 9, comprising:
a wireless data interface.
